(19) United States
(12) Patent Application Publication
(10) Pub. No.: US 2004/0098272 A1
(43) Pub. Date: May 20, 2004

(54) Computer based system for tracking articles

(76) Inventors: James Kapsis, Searingtown, NY (US); Robert Ross, Oyster Bay, NY (US)

Correspondence Address: WILLIAM COLLARD, COLLARD & ROE, P.C., 1077 NORTHERN BOULEVARD, ROSLYN, NY, 11576, US

(21) Appl. No.: 10/294,847

(22) Filed: Nov. 14, 2002

(51) Int. Cl. G06F 17/60

(52) U.S. Cl. 705/1

(57) ABSTRACT

A system and a process for tracking cargo through customs. The system includes a computerized network which includes one or more servers which contain and process information for tracking items through customs. The system includes a database server, a remote relay computer, and a remote scanner for which is in communication with the remote relay computer. The scanner is used to communicate with both bar code labels and Radio Frequency Identification or RFID labels which then sends the information back to the remote relay computer and on to the server. In a preferred embodiment, the RFID labels are used instead of the bar code labels. The process is designed to take information from a shipper, store this information in a database and tag this information to a RFID label. This RFID label is then attached go goods that are shipped so that the goods can be tracked as they pass through customs. Because each label is associated with a database that tracks the goods on their shipment customs officers can let the good pass if the description of the goods and their travel route match the information in the database.

### BACKGROUND

The invention relates to a system and process for tracking cargo through customs. This system includes a computerized network including a program for controlling the process and a database for storing information. The process includes a plurality of steps for authenticating and tracking goods as they pass through customs and on to their final destination. Currently, only about 2% of all shipments into the United States are searched or examined by the U.S. Customs Service.

According to the U.S. Customs Bureau, when a shipment reaches the United States, the importer of record (i.e., the owner or distributor, the purchaser, or licensed customs broker designated by the owner, purchaser, or consignee) will file entry documents for the goods with the port director at the port of entry. Imported goods are not legally entered until after the shipment has arrived within the port of entry, delivery of the merchandise has been authorized by Customs, and estimated duties have been paid. It is the responsibility of the importer of record to arrange for examination and release of the goods.

Goods may be entered only by the owner/distributor, purchaser, or by a licensed customs broker. When the goods are consigned “to order,” the bill of lading, properly endorsed by the consignor, may serve as evidence of the right to make entry. An air waybill may be used for merchandise arriving by air.

In most instances, entry is made by a person or firm certified by the carrier bringing the goods to the port of entry. This entity is considered the “owner” of the goods for customs purposes. The document issued by the carrier is known as a “Carrier's Certificate.” In certain circumstances, entry may be made by means of a duplicate bill of lading or a shipping receipt. When the goods are not imported by a common carrier, possession of the goods by the importer at the time of arrival shall be deemed sufficient evidence of the right to make entry.

Within five working days of the date of a shipment's arrival at a U.S. port of entry, entry documents must be filed at a location specified by the port director, unless an extension is granted. These documents consist of: 1) Entry Manifest (Customs Form 7533) or Application and Special Permit for Immediate Delivery (Customs Form 3461) or other form of merchandise release required by the port director; 2)Evidence of right to make entry; 3) Commercial invoice or a pro forma invoice when the commercial invoice cannot be produced; 4) Packing lists if appropriate; 5) Other documents necessary to determine merchandise admissibility.

If the goods are to be released from Customs custody on entry documents, an entry summary for consumption must be filed and estimated duties deposited at the port of entry within 10 working days of the time the goods are entered.

In an effort to speed up the processing of shipments through customs, an alternate procedure which provides for immediate release of a shipment may be used in some cases by making an application for a special permit for immediate delivery on Customs Form 3461 prior to the arrival of the merchandise. Carriers participating in the Automated Manifest System (AMS) can receive conditional release authorizations after leaving the foreign country and up to five days before landing in the United States. If the application is approved, the shipment is released expeditiously following arrival. An entry summary must then be filed in proper form, either on paper or electronically, and estimated duties deposited within 10 working days of release.

Immediate-delivery release using Form 3461 is limited to the following types of merchandise: 1) Merchandise arriving from Canada or Mexico, if approved by the port director and an appropriate bond is on file; 2) Fresh fruits and vegetables for human consumption arriving from Canada or Mexico and removed from the area immediately contiguous to the border to the importer's premises within the port of importation; 3) Shipments consigned to or for the account of any agency or officer of the U.S. government; 4) Articles for a trade fair; 5) Tariff-rate quota merchandise and, under certain circumstances, merchandise subject to an absolute quota (Absolute quota items require a formal entry at all times); 6) In very limited circumstances, merchandise released from warehouse followed within 10 working days by a warehouse withdrawal for consumption; 7) Merchandise specifically authorized by Customs Headquarters to be entitled to release for immediate delivery.

Merchandise arriving in the United States by commercial carrier must be entered by the owner, purchaser, his or her authorized regular employee, or by the licensed customs broker designated by the owner, purchaser, or consignee. U.S. Customs officers and employees are not authorized to act as agents for importers or forwarders of imported merchandise, although they may give all reasonable advice and assistance to inexperienced importers.

The U.S. Customs Office has determined that examination of goods and documents is necessary to determine, among other things: 1) The value of the goods for customs purposes and their dutiable status; 2) Whether the goods must be marked with their country of origin or require special marking or labeling (If so, whether they are marked in the manner required); 3) Whether the shipment contains prohibited articles (such as those articles that may infringe on intellectual property rights); 4) Whether the goods are correctly invoiced; 5) Whether the goods are in excess of the invoiced quantities or a shortage exists; 6) Whether the shipment contains illegal narcotics.

Prior to the goods' release, the port director will designate representative quantities for examination by Customs officers under conditions that will safeguard the goods. Some kinds of goods must be examined to determine whether they meet special requirements of the law. For example, food and beverages unfit for human consumption would not meet the requirements of the Food and Drug Administration.

One of the primary methods of smuggling narcotics into the United States is in cargo shipments. Drug smugglers will place narcotics inside a legitimate cargo shipment or container to be retrieved upon arrival in the United States. Because smugglers use any means possible to hide narcotics, all aspects of the shipment are examined, including container, pallets, boxes, and product. Only through intensive inspection can narcotics be discovered.

Customs officers will ascertain the quantity of goods imported, making allowances for shortages under specified conditions and assessing duty on any excess. The invoice may state the quantities in the weights and measures of the country from which the goods are shipped or in the weights and measures of the United States, but the entry must state the quantities in metric terms.

The present system and process integrates a system and process for tracking items using RFID labels with the process used by customs to track and grant entrance of goods into the United States. These RFID labels are tied to a database which contains information that is necessary for U.S. customs officials to process goods passing through customs.

### SUMMARY

The invention relates to both a system and a process for tracking cargo through customs. The system includes a computerized network which includes one or more servers which contain and process information for tracking items through customs. The system includes a database server, a remote relay computer, and a remote scanner which is in communication with the remote relay computer. The scanner can either send and receive information from the server wirelessly through the remote relay computer which can be in the form of a pc or personal computer. In addition, the remote relay computer can also be a docking station which allows the scanner to upload or download information which is stored on the database server. The scanner is used to communicate with both bar code labels and Radio Frequency Identification or RFID labels. The scanner sends the information back to the remote relay computer either wirelessly or via docking, and then on to the server. In a preferred embodiment, the RFID labels are used instead of the bar code labels.

The process for tracking shipments from a user through a nation's customs ports includes a plurality of steps. First the shipping information can be received from the user or customer. This shipping information can be in the form of the origin of the shipment, the destination of the shipment, the different way points or ports of entry in the shipment, a description of the goods being shipped, the quantity of the goods being shipped, the packaging arrangement of the shipment, the owner of the shipment, and the name of the shipper. This shipping information is next sorted and stored in a database. Once this shipping information has been received, a label can be created.

This label has a label ID and links to the database to reveal all of the information about the shipment to a customs official. One of these labels can then be sent to the user. The label can then be applied to the correct package so that it is properly identified during shipment. Finally this shipment is tracked via a customs official who can read the RFID tags on the goods being shipped using a hand held scanner.

### BRIEF DESCRIPTION OF THE DRAWINGS

Other objects and features of the present invention will become apparent from the following detailed description considered in connection with the accompanying drawings which disclose at least one embodiment of the present invention. It should be understood, however, that the drawings are designed for the purpose of illustration only and not as a definition of the limits of the invention.

In the drawings, wherein similar reference characters denote similar elements throughout the several views:

FIG. 1 is a flow chart of the process for tracking goods through customs;

FIG. 2 is a schematic diagram of the system for tracking goods through customs;

FIG. 3 is a schematic block diagram of the database for tracking goods through customs;

FIG. 4 is a flow chart showing a more detailed version of the process for tracking goods through customs;

FIG. 5A is a detailed view of a table for identifying a user-owner distributor;

FIG. 5B is a detailed view of a table for identifying a user-manufacturer;

FIG. 5C is a detailed view of a table for identifying a user-shipper;

FIG. 6A is a detailed view of a table showing the information relating to the goods being shipped;

FIG. 6B is a detailed view of a table showing the information relating to the exact shipment being sent; and

FIG. 6C is a detailed view of a table for tracking the individual goods being shipped as they relate to their cartons and containers;

FIG. 6D is a detailed view of the table for tracking the containers, the cartons and the individual items as they pass different entry ports.

### DETAILED DESCRIPTION

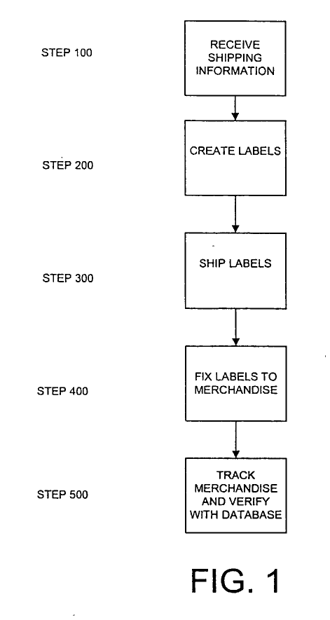

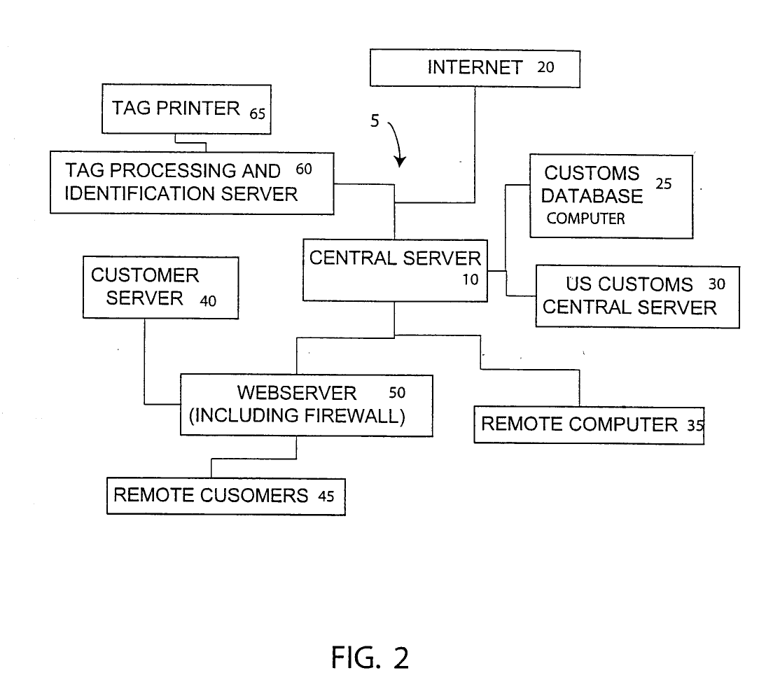

Referring in detail to the drawings, FIG. 1 is a flow chart showing an overview of the process for tracking goods through customs. This flow chart begins with step series 100, wherein a central host such as a data processing company, which controls a computer, such as central server 10 in FIG. 2, receives shipping information from a user-shipper who can be an owner of goods to be shipped. In step series 200 labels are created wherein these labels contain an identifier that relates each label to the shipping information sent in from the shipper. In step series 300, the labels are shipped from the host to the shipper wherein in step series 400 these labels are affixed to the goods to be shipped. Finally, in step series 500, these goods are tracked and verified using a database.

FIG. 2 is a schematic block diagram of the system for tracking goods being shipped through customs. As shown there is a central server 10 that is in communication with a plurality of other computing systems. Central server 10 can be one single server computer or one or more servers which process information used in the process shown in FIG. 1. The communication between central server 10 and the other computers can be through telecommunication lines, wirelessly or through any other communication channel known in the art. Central server 10 is in communication with the Internet 20, a customs database 25, a customs central server 30, one or more remote computers 35, which can be in the form of a pc or a docking station, a remote customer 45 who logs into central server 10 via a firewall 50, a customer server 40 which is also in communication with firewall 50. There is also a tag processing and identification server 60 which is in communication with central server 10 and a tag printer 65. Central server 10 runs a program 11 which acts as a central host for processing the information communicated between the different computers. Central server 10 also contains one or more databases which are used to store information relating to the goods being shipped through customs. Essentially, any one of these companies can connect to central server 10 either directly or through the Internet.

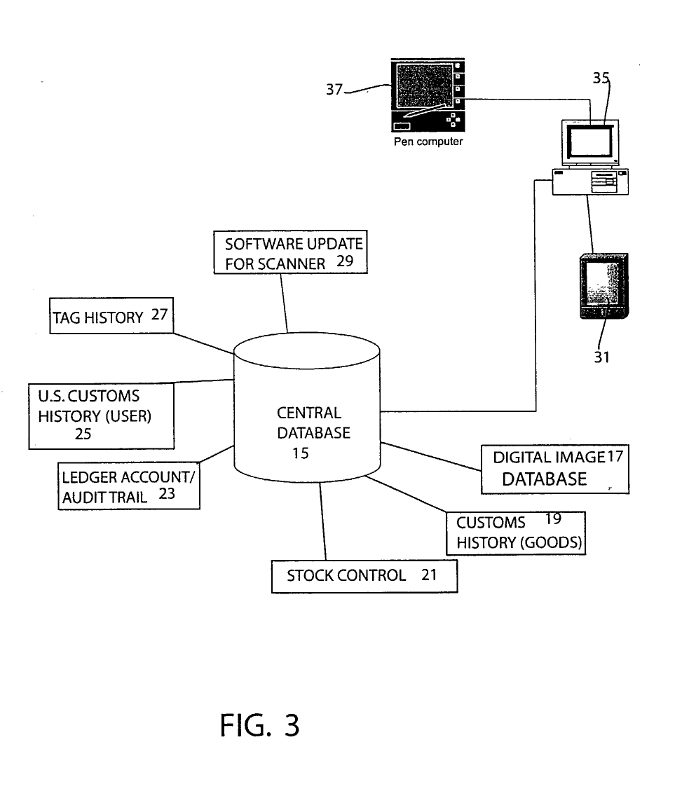

FIG. 3 is a schematic block diagram of the database for tracking goods through customs. These different databases can all be stored in different computers or all on the same computer. FIG. 3 also shows the other databases as they connect to each other. For example, a central database 15, which can reside on central server 10, is in communication with data associated with a digital image stored in a digital image database 17. Central database 15 is also in communication with a customs database 19 wherein customs database 19 sends and receives customs information to central database 15. Customs database 19 can be stored in U.S. customs central computer 30 shown in FIG. 2.

A stock control database 21 is also in communication with central database 15, wherein stock control database 21 sends and receives information relating to the stock items being shipped and tracks the ports in which they are shipped through. A ledger account database 23 is also in communication with central database 15, wherein ledger account database 23 tracks the lawful transfer of goods from one party to another. Both stock control database 21 and ledger control database 23 can be stored on customer server 10. There is also a U.S. customs history database 25 which tracks the history of either a manufacturer, a distributor, a consolidator or a shipper. A tag history database 27 is also in communication with central database 15 wherein tag history database 27 sends and receives data back and forth with central database 15 so that central database 15 can be used to track the movement of each tag throughout the shipment. There is also a database for holding software updates for scanners 29, wherein this database can be used so that information can be downloaded to the individual scanners 31 so that these individual scanners can have the latest operating system installed therein. Update database 29 can be stored on central server 10.

Scanners 31 are in communication with a remote computer 35. In addition, a second type of scanner or pen based scanner 37 can also be in communication with remote computer 35. Scanner 31 can be a modified palm based device having an attached scanner. The scanner can be fabricated integral with the palm based device or attached as an after market part. The device can use a modified Palm OS software, windows CE type software or any other type software which allows the remote scanning of RFID tags or barcodes and then links to a central database. Scanners 31 can also have a biometric scanning device which initializes when a user places his thumb or finger on the scanner for identification. This biometric verification insures that the identity of the Customs Official is determined when that customs official is scanning items through customs. Scanner 31 starts to process the cargo containing tags when it receives an authentication from central server 10 that the thumb print or fingerprint of the user has been authenticated.

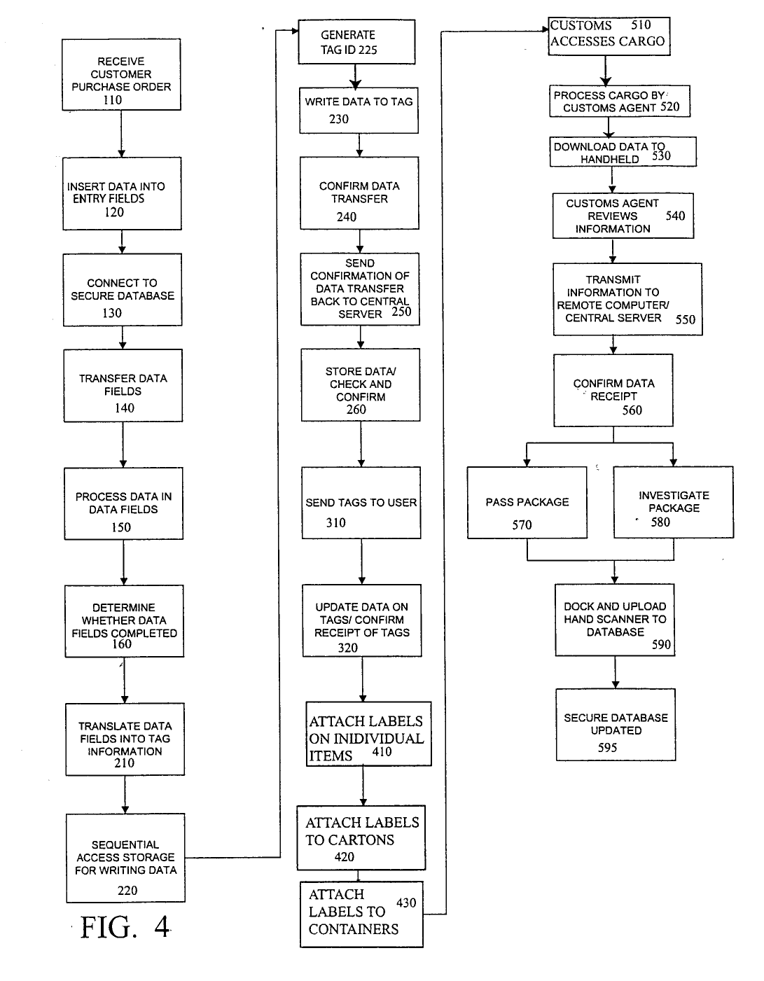

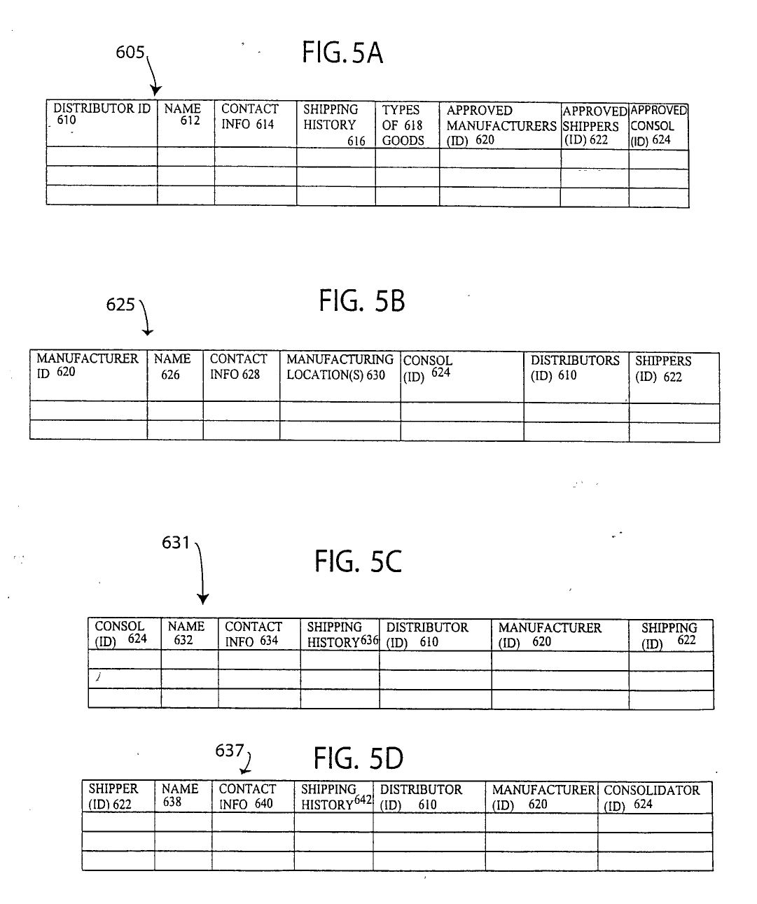

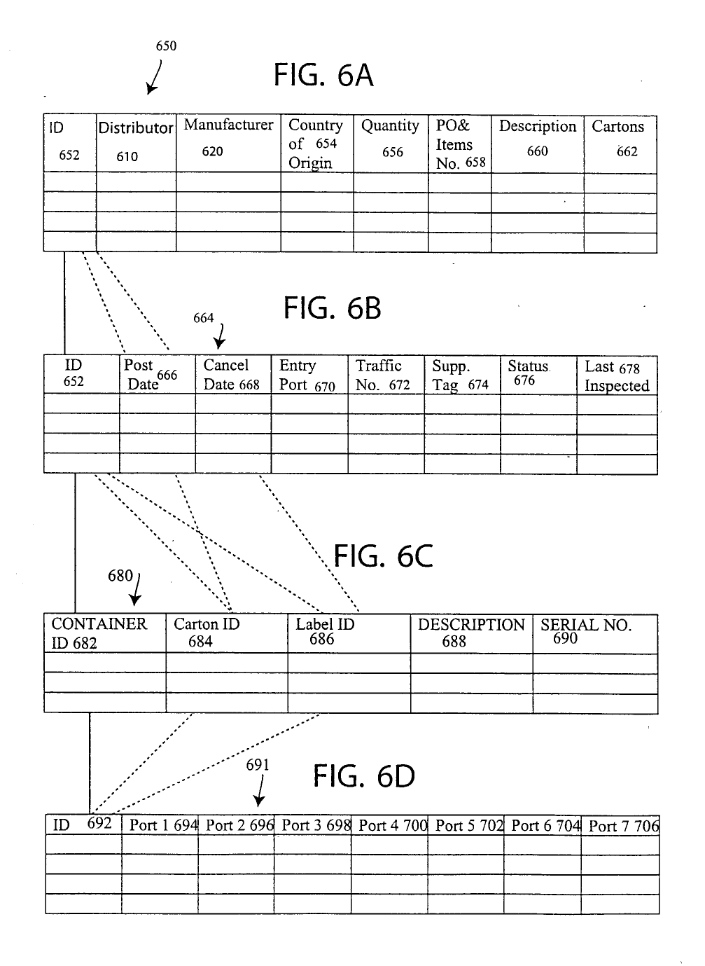

FIG. 4 is a flow chart showing a more detailed version of the process for tracking goods through customs. The process starts with step 110 wherein the host receives a customer purchase order. This order can either be mailed, faxed or electronically transferred to the central host station containing central server 10. The customer purchase order contains data that can be inserted into data fields shown in FIGS. 5A, 5B, 5C, 6A, 6B, 6C and 6D. In particular, the customer, which in most cases is the distributor, inserts information relating to the person or company that will own the goods associated with the tags. This information as shown in table 605 in FIG. 5A can be the distributor ID 610, the distributor name 612, the contact information for the distributor 614, the shipping history of the distributor 616, the type of the goods being shipped 618, the approved manufacturers 620, and the approved shippers 622.

In addition, the customer can also enter information about the manufacturer as shown in table 625 in FIG. 5B. This table includes the manufacturer's ID 620, the name of the manufacturer 626, the contact information of the manufacturer 628, the manufacturing location 630, the manufacturing history 632, the distributors ID, and the supplier's ID. As shown in FIG. 5C and in table 635, the client can also forward information relating to the shipper's ID in field 634, the name of the shipper 636, the shipping history 640. This table also shows that the distributor ID 610 and the manufacturer ID 620 can both be associated with the shipper ID.

FIG. 5C shows table 631 which contains fields relating to the consolidator. For example there is a consolidator ID 624, the consolidator's name 632, the contact information for the consolidator 634, the shipping history 636, the related distributor ID's, the associated manufacturer's ID 620 and the shipping id 622. This table allows a customs official to track the history and associations of all of the consolidators. In that way, if a shipment associated with a particular consolidator does not follow that consolidator's previous history then the customs official can review the container more closely. However, in most instances if the present shipment is being shipped with all of its proper identification then a customs official can allow the shipment to move through the customs checkpoints quickly.

FIG. 5D shows table 635 which lists the shipper ID 622, the name of the shipper 636, the contact information 638, the shipping history 640, the distributor ID 610, and also the manufacturer ID 620. Table 637 is similar to table 631 wherein in many cases, the shipper and the consolidator are the same entity.

As shown in FIG. 4, step 120 includes inserting these fields in a data entry page. The information entered in a remote computer 35 which is entered and then in step 130, this remote computer is connected to a secure database 15. In step 140, this information is transferred so that this information is then processed in step 150 in the data fields shown in FIGS. 5A-5D. In step 160, central server 15 determines whether these data fields have been completed. If the data fields have not been completed, then central server 15 sends a request back to a customer for more information on the customer purchase order.

Step series 200 includes the process for manufacturing the tag. For example, in step 210 the information from the data fields is transformed into tag information. This step includes generating a tag Id for the information already entered. Each tag contains a tag ID so that when all of the data has been entered into central database 15 a new tag ID is created and associated with each tag. When a customs official scans the tag, information relating to that tag that is secured to that tag ID is forwarded to remote scanners 31 or 37 so that the user such as a customs official has access to the database information associated with that tag. This information then appears on video or on display screens on the palm device. In that way the cargo can be tracked quickly and efficiently.

In step 220, the information relating to the tag is sequentially transferred back and forth between a remote data entry computer and central computer or server 10 housing central database 15. In step 225, central server 10 creates a tag ID 652 which is shown in FIGS. 6A-6D. In step 230, tag printer 65 creates a tag wherein tag data including tag ID 652 is written to the tag wherein in step 240 the data transfer is later confirmed. In step 250 this confirmation is then later sent back to central server 10 housing central database 15. In step 260 the information relating to that tag is then stored, checked and then later confirmed.

Step series 300 includes the steps for sending these tags and confirming the receipt of the tags. For example, step 310 includes sending these tags to the user or customer who requests the tags. Essentially sheets of these tags are mailed out to the customers who request these tags. Aside from the internally generated tag ID, the other entry fields shown in FIGS. 6A-6D can be entered either by the host internally or remotely by the customer receiving the tag. Next, step 320 includes the step of updating the data on the tags and confirming the receipt of the tags.

Step series 400 includes the process for adding tags to containers, cartons, and individual items being shipped. For example, in step 410, the tags associated with each individual item are attached to each of these items. Next these individual items are stored in boxes. These boxes are also then labeled with tags in step 420. Finally, in step 430, these boxes are either placed inside a container, or shipped to a consolidator or shipper wherein they are placed inside of a container for shipping.

Step series 500 includes the steps for examining and processing the cargo containing these tags. In step 505, the customs agent docs scanner 31 in a docking station wherein scanner 31 uploads up to 100,000 tag entries into scanner 31. The tag entries include security information shown in tables 605, 625, 631, 637, 650, 664, 680 and 691. The tag entries are selected and downloaded based upon the time and date of the download and the location of the docking station. Thus, scanner 31, will upload the 100,000 most proximate tag entries based upon time date and location so that scanner already contains the necessary information to display all of the necessary information related to the tags. In step 510, a customs agent accesses the cargo. The customs agent accesses this cargo by having this cargo unloaded at a port of entry. Next, in step 520, this information is processed by a customs agent by reading the bill of lading, the visa, or the air shipment manifest and also scanning the RFID tag and any bar code tags. When the Lag on the container is scanned, information about the contents of the container are downloaded in step in step 530 and appear on a video display on scanner 31. This information can include information from tables 650, 664, 680, and 691 shown in FIGS. 6A-6D. Next, in step 540 a customs agent reviews this information to verify the identity of the container and the contents held therein. In step 550 the customs agent can then transmit any updating information about the shipment to central server 10. In step 560 central server 10 can then confirm the receipt of this date. Based upon the information obtained by the customs official, this official can determine whether to pass this package through customs in step 570 or to investigate this package further as shown in step 580.

Step 580 which includes the investigation of the container being shipped can involve having the customs official open each of the containers wherein the containers are then examined further by pulling boxes or cartons out of the containers. These boxes or cartons can be each identified with a label wherein as shown in FIG. 6C the container ID the carton ID and the are all associated with each other for easier tracking. The boxes and cartons can also be opened to further examine and scan the contents of the boxes.

Once all of the items have either passed through customs or have been investigated, the handheld scanner can then send an update or report on the condition of the goods being passed through.

For example, in step 590 scanner 31 can be docked to update its information to central database 15. Next, in step 595 central database 15 on central server 10 is updated with the information relating to the goods passing through customs.

Thus, this system allows a customs official using a hand held scanner to rapidly verify goods passing through customs. Goods associated with these RFID tags and central database 10 can be easily authenticated in a much more rapid manner than previous methods involving reading bills of lading and air freight manifests.

Accordingly, while at least one embodiment of the present invention has been shown and described, it is to be understood that many changes and modifications may be made thereunto without departing from the spirit and scope of the invention as defined in the appended claims.

What is claimed is:

1. A computerized process for tracking shipments from a user through a nation's customs ports comprising the following steps:
a) receiving shipping information from the user;
b) storing said shipping information in a database;
c) creating at least one label for tracking at least one shipment to be sent by the user wherein said label is associated with said database;
d) sending said at least one label to said user;
e) applying said at least one label to said at least one shipment; and
f) tracking said at least one shipment using said database and said at least one label.

2. The process as in claim 1, wherein said step of receiving shipping information includes the step of receiving a customer purchase order which includes the number of labels to be sent, a description of the items to be associated with these labels, a destination for these labels, the name of the purchaser, and the name of the shipper.

3. The process as in claim 2, further comprising the step of receiving information relating to the port of destination of the shipment.

4. The process as in claim 3, further comprising the step of receiving information relating to any intermediate port between a shipment port and said port of destination.

5. The process as in claim 1, wherein said step of storing said shipping information in said server includes the steps of inserting data related to said shipping information including data fields into said database; connecting to said database; transferring data fields into said database; processing said data in said data fields; and determining whether said data in said data fields is complete.

6. The process as in claim 1, wherein said step of creating at least one label includes the steps of translating said data in said data fields into tag information.

7. The process as in claim 6, wherein said step of creating at least one label includes sequentially accessing said translated data; writing said data to said at least one tag; and confirming said data transfer.

8. The process as in claim 7, wherein said step of creating at least one label further comprises the steps of sending a confirmation of data transfer back to a central server; storing said data, checking said data and confirming said data.

9. The process as in claim 1, wherein said step of sending said at least one label includes updating said database to confirm when said user receives said at least one label.

10. The process as in claim 1, wherein said step of applying said at least one label includes applying at least one label to at least one container for shipping a plurality of goods.

11. The process as in claim 10, further comprising the step of applying at least one additional label to at least one carton for holding said plurality of goods wherein said at least one carton fits inside said at least one container.

12. The process as in claim 10, wherein said step of applying at least one label includes applying at least one label to at least one individual item of goods, wherein said at least one individual item of goods is stored in said at least one container.

13. The process as in claim 1, wherein said step of tracking said at least one shipment includes examining said at least one shipment by a customs agent.

14. The process as in claim 1, wherein said step of tracking said at least one shipment includes the step of reading said at least one label coupled to said at least one container and transferring data from said at least one label to a central database.

15. The process as in claim 14, wherein said step of tracking said at least one shipment includes the step of confirming the receipt of said data transferred to said central database.

16. The process as in claim 14, further comprising the step of updating said data in said central database.

17. The process as in claim 1, further comprising the step of uploading information from said database into a scanner for reading and tracking said at least one label.

18. The process as in claim 17, wherein said step of downloading information from said database into said scanner includes uploading time, date, location, and identity data associated with said at least one label.

19. The process as in claim 18, wherein said database selects and downloads information of a preselected number of the most proximate labels from said database based upon time, date, and location data of each of said label data compared to the time, date and location of the download.

20. A system for tracking articles through customs comprising:
a) a central server;
b) a portable scanner in communication with said central server said scanner having a display for displaying information;
c) a plurality of labels, wherein each label has an electronic ID and wherein each label is attachable to an item passing through customs; and
d) a database stored in said central server, said database containing a data element linked to said electronic ID on said label, said database also containing information stored in additional data fields relating to the items passing through customs, wherein when said portable scanner scans at least one of said plurality of labels, said portable scanner uploads said data element associated with said electronic id and any of said additional data to said portable scanner so that said data element and said additional data are viewable on said display.

20. The system as in claim 19, wherein said portable scanner further comprises a biometric authentification device which authenticates the user of said portable scanner and wherein said portable scanner uploads the identity of the portable scanner user to said database.

21. The system as in claim 19, wherein said scanner is coupled to a hand held organizer.

22. The system as in claim 19, wherein said scanner communicates with said central server wirelessly.
